(19) United States
(12) Patent Application Publication
(10) Pub. No.: US 2026/0052371 A1
(43) Pub. Date: Feb. 19, 2026

(54) METHODS AND SYSTEMS FOR HANDLING FPLMNS FOR MINT

(71) Applicant: SAMSUNG ELECTRONICS CO., LTD., Suwon-si, Gyeonggi-do (KR)

(72) Inventors: Lalith KUMAR, Bangalore (IN); Aman AGARWAL, Bangalore (IN); Kailash Kumar JHA, Bangalore (IN); Mahmoud WATFA, Bangalore (IN)

(21) Appl. No.: 19/102,256

(22) PCT Filed: Aug. 9, 2023
(86) PCT No.: PCT/KR2023/011782

§ 371 Date: Feb. 7, 2025

(30) Foreign Application Priority Data
Aug. 9, 2022 (IN) 202241045543
Sep. 27, 2022 (IN) 202241055396
Jul. 20, 2023 (IN) 202241045543

(51) Int. Cl. H04W 8/08; H04W 60/04; H04W 84/04

(52) U.S. Cl. CPC H04W 8/08; H04W 60/04; H04W 84/042

(57) ABSTRACT

The disclosure relates to a 5G or 6G communication system for supporting a higher data transmission rate. Embodiments herein disclose methods and systems for handling FPLMNs for MINT. Embodiments herein disclose methods and systems for managing selection of PLMNs in wireless communication networks, during a disaster situation. Embodiments herein disclose methods and systems for managing selection of PLMNs in wireless communication networks, during a disaster situation, wherein the UE transitions from Disaster Roaming Service to Normal Service on the same PLMN-A, when PLMN-A is included in the list of preferred PLMN/access technology combinations provided in the Steering of Roaming (SOR) information to the UE. Embodiments herein disclose methods and systems for managing selection of PLMNs in wireless communication networks, during a disaster situation, wherein the UE can avail disaster roaming services from PLMN-A for other PLMN(s) with disaster condition (for e.g., PLMN-D2) when the UE was initially registered on PLMN-A for disaster roaming services for PLMN-D (which has faced disaster situation).

### TECHNICAL FIELD

The present invention relates to a wireless communications and systems, and more specifically related to methods and systems for handling Forbidden Public Land Mobile Networks (FPLMNs) for Minimization of service interruption (MINT).

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for cf-ficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The purpose of a Minimization of service interruption (MINT) is to minimize interruption of service to users when the network to which these users are subscribed cannot provide service due to a disaster scenario (such as, but not limited to a fire, an earthquake, a flood, a landslide, a storm, a terrorist attack, and so on). MINT enables users to obtain service on other networks, while at the same time protecting those other networks from congestion.

FIG. 1 depicts a scenario, wherein a UE is trying to transition from Disaster Roaming Service to Normal Service on the same PLMN-A, when the PLMN-A is included in the list of preferred PLMN/access technology combinations provided in the Steering of Roaming (SOR) information to the UE. In step 1, a UE supporting Disaster Roaming or Minimization of Service Interruption (MINT), is in a disaster situation, can select and register using 5GS Registration Type value as “disaster roaming initial registration” or using 5GS Registration Type value as “disaster roaming mobility registration updating” on a PLMN (PLMN-A) which is present in the Forbidden PLMN List (FPLMN List) of the UE and providing disaster roaming services to the UE on behalf of a PLMN (PLMN-D) (which is allowable or not a part of UE's Forbidden PLMN List and has faced the disaster situation). PLMN-D is allowable PLMN for the UE; i.e., PLMN-D is not part of the UE's FPLMN list and the PLMN-D has faced disaster situation. The PLMN-A is part of UE's Forbidden PLMN List (FPLMN List). PLMN-A is available and providing disaster roaming services to the UE on behalf of PLMN-D which has faced disaster situation. If the UE is registered on a visiting PLMN i.e., VPLMN (PLMN-A) for Disaster Roaming services, the UE shall disable the S1 mode. If the UE supports S1 mode, the UE may not indicate the S1 mode support in the REGISTRATION REQUEST message or the UE may set the S1 mode bit to “S1 mode not supported” in the 5GMM capability IE of the REGISTRATION REQUEST message or the UE shall indicate to the Network (any Network function or entity) through AS/NAS signalling message that S1 mode is not supported for the UE if the UE is registering for disaster roaming services.

In step 2, if the UE is registered on a visiting PLMN (i.e., VPLMN (PLMN-A)) for disaster roaming services, the HPLMN can provide the Steering of Roaming (SOR) information to the UE in the DL NAS TRANSPORT message or via any AS/NAS Signalling Message. The UE shall:
a) replace the highest priority entries in the “Operator Controlled PLMN Selector with Access Technology” list stored in the ME with the list of preferred PLMN/access technology combinations provided in the Steering of Roaming (SOR) information;
b) delete the PLMNs identified by the list of preferred PLMN/access technology combinations provided in the Steering of Roaming (SOR) information from the Forbidden PLMN list and from the Forbidden PLMNs for GPRS service list, if they are present in these lists. This includes any information stored in the SIM and the ME internal memory;
c) take the new information into account in subsequent attempts to access a higher priority PLMN.

In step 3, if PLMN-A, on which UE is registered for Disaster Roaming services on behalf of PLMN-D which has faced disaster situation, is included in the list of preferred PLMN/access technology combinations provided in the Steering of Roaming (SOR) information to the UE or if the PLMN-A is indicated as allowable PLMN (i.e., not a part of UE's forbidden PLMN list) in any of the IE (for example, 5GS Registration Result IE) included in the REGISTRATION ACCEPT message or if the PLMN-A becomes allowable PLMN (i.e., not a part of UE's forbidden PLMN list) for the UE due to any reason or through any AS/NAS signalling message, the UE shall delete PLMN-A from the FPLMN list and PLMN-A will be allowable PLMN (i.e. no more a forbidden PLMN) for the UE. Thus, the UE is potentially eligible to avail normal services on PLMN-A, but the UE is currently stuck with PLMN-A to receive disaster service (which does not provide full services for which UE is eligible). Currently, there is no method defined to transition the UE from Disaster Roaming Service to Normal Service on same PLMN-A.

FIG. 2 depicts a scenario, wherein the UE can avail disaster roaming services from PLMN-A2 for other PLMN(s) with disaster condition (for e.g., PLMN-D2) when the UE was initially registered on PLMN-A2 for disaster roaming services for PLMN-D1 (which has faced disaster situation). PLMN-D1 is an allowable PLMN for the UE i.e., PLMN-D1 is not part of UE's FPLMN list and PLMN-D1 has faced disaster situation. PLMN-D2 is an allowable PLMN for the UE i.e., PLMN-D1 is not part of UE's FPLMN list and PLMN-D1 has faced disaster situation. In step 1, PLMN-A2 is part of the UE's Forbidden PLMN List (FPLMN List). PLMN-A1 is alive and is broadcasting an indication of accessibility for Disaster Roaming Service to the UE. The PLMN-A can optionally broadcast a “list of PLMN(s) with Disaster condition (for e.g., PLMN-D1, PLMN-D2) for which Disaster Roaming is offered by the available PLMN in the impacted area”. In step 2, a UE supporting Disaster Roaming or Minimization of Service Interruption (MINT), in a disaster situation, can select and register using 5GS Registration Type value as “disaster roaming initial registration” or using 5GS Registration Type value as “disaster roaming mobility registration updating” on a PLMN (PLMN-A1) which is present in the FPLMN list of the UE and providing disaster roaming services to the UE on behalf of a PLMN (PLMN-D1) (which is allowable or not a part of the UE's Forbidden PLMN List and has faced the disaster situation). In step 3, the PLMN-A1, on which UE is registered for Disaster Roaming services for PLMN-D1 which has faced disaster situation, stops broadcasting or stops including PLMN-D1 in the “list of PLMN(s) with Disaster condition for which Disaster Roaming is offered by the available PLMN in the impacted area” but broadcasts or includes or adds PLMN-D2 as the PLMN(s) with Disaster Condition in the “list of PLMN(s) with Disaster condition for which Disaster Roaming is offered by the available PLMN in the impacted area”. In step 4, there is no other available PLMN(s) offering disaster roaming services to the UE apart from PLMN-A1. It is not defined how the UE would avail disaster roaming services from PLMN-A2 for other PLMN(s) with disaster condition (for e.g., PLMN-D2) when the UE was initially registered on PLMN-A1 for disaster roaming services for PLMN-D1 (which has faced disaster situation).

In an example scenario (as depicted in FIG. 3), PLMN D (or PLMN-D) is subject to a disaster (i.e., PLMN-D is the PLMN with the disaster condition) and PLMN A (PLMN-A) is alive and not subject to a disaster. PLMN-A is a forbidden PLMN (FPLMN) to the UE. PLMN-A may provide disaster roaming service to the users of the PLMN-D (i.e., to the Disaster Inbound roamers of the PLMN-D). In step 1, PLMN-A1 broadcasts an indication of accessibility for Disaster Roaming Service. PLMN-A1 can optionally broadcast a “list of one or more PLMN(s) with disaster condition (for example, PLMN-D1, PLMN-D2) for which disaster roaming is offered by the available PLMN” (i.e., PLMNs with disaster condition for which PLMN-A1 is providing disaster roaming services). In step 2, the UE registers using 5GS Registration Type value as “disaster roaming initial registration” or using 5GS Registration Type value as “disaster roaming mobility registration updating” on PLMN A1 for Disaster Roaming service for PLMN-D1. In step 3, the PLMN-A1, on which UE is registering for Disaster Roaming services for PLMN-D1 which has faced the disaster condition, rejects the registration request of the UE (through any AS or NAS signalling messages, for example, Registration reject etc.) with any of the following 5GMM reject causes: 5GMM cause values #11 “PLMN not allowed”; 5GMM cause values #73 “Serving network not authorized; and #31 (Redirection to EPC required). In step 4,
The PLMN-A1, on which UE is registering for the disaster roaming service and from which UE gets a 5GMMreject cause (#11 or #73), maybe the highest in the priority order (i.e., the most preferred PLMN ID in the list) in the “list of PLMN(s) to be used in disaster condition” stored in the ME/USIM which is associated with the PLMNID of the MS determined PLMN with disaster condition (for example, PLMN-D1), if any; or
If the ME/USIM does not have a stored “list of PLMN(s) to be used in disaster condition” associated with the PLMN ID of the MS determined PL MN with disaster condition, PLMN-A2 may be the highest in the priority order (i.e., the most preferred PLMN ID in the list) in the “list of PLMN(s) to be used in disaster condition”, stored in the ME/USIM which is associated with the PLMN ID of the HPLMN (of the UE), if any; or
There is no other available PLMN(s) offering disaster roaming services to the UE apart fromPLMN-A1; or
Optionally, there is no allowable PLMN which can provide normal services to the UE; or
Optionally, the MS is not in 5GMM-REGISTERED state and 5GMM-CONNECTED mode over non-3GPPaccess.

In step 5, the UE may consider PLMN-A2 as the highest priority PLMN for registering for disaster roaming services and UE registers, again, using5GSRegistrationTypevalucas″disaster roaming initial registration” or using 5GS Registration Type value as “disaster roaming mobility registration updating” on PLMN A1 for Disaster Roaming service for PLMN-D1. In step 6, the PLMN-A2 rejects, again, the registration request of the UE (through any AS or NAS signalling messages) with any of the 5GMM reject causes (#11 or #73):

The steps (2-6) may be repeated again and again (for example, in a repetitive manner or in a loop) and the UE may unnecessarily select and register on PLMN-A1 for disaster roaming services even after getting the 5GMM reject cause (#11or #73). This may lead to unnecessary wastage of UE and Network resources (for example, signalling resources).

Currently, it is not defined how the UE or the Network would avoid a situation to not let the UE to repeatedly register on a PLMN (for example, PLMN-A1) for disaster roaming services, when the UE was initially registering on PLMN-A2 for disaster roaming services for PLMN-D1 (which has faced disaster condition) and PLMN-A2 is rejecting the registration request of the UE (through any AS or NAS signalling messages, for example, Registration reject etc.) with any of the 5GMM reject causes (#11or #73).

FIG. 3 illustrates a scenario of how to handle abnormal case for receipt of 5GMM cause value, according to prior arts. Considering the conventional methods and systems, PLMN-D1 is allowable PLMN for the UE; i.e., PLMN-D1 is not part of UE's FPLMN list and PLMN-D1 has faced disaster condition. PLMN-D2 is allowable PLMN for the UE; i.e., PLMN-D2 is not part of UE's FPLMN list and PLMN-D2 has faced disaster condition.

PLMN-A2 is part of UE's FPLMN list or present in the list of “forbidden PLMNs” or the list of “forbidden PLMNs for GPRS service”. PLMN-A2 is alive and is broadcasting an indication of accessibility for Disaster Roaming Service to the UE. PLMN-A can optionally broadcast a “list of one or more PLMN(s) with disaster condition (for example, PLMN-D1, PLMN-D2) for which disaster roaming is offered by the available PLMN”.

A UE supporting Disaster Roaming or Minimization of Service Interruption (MINT), in a disaster condition, can select and register (through any AS or NAS signalling messages, (for example, Registration Request etc.)) using 5GS Registration Type value as “disaster roaming initial registration” or using 5GS Registration Type value as “disaster roaming mobility registration updating” on a PLMN (PLMN-A1) which is present in the FPLMN list of the UE and providing disaster roaming services to the UE on behalf of a PLMN (PLMN-D1) (which is allowable or not a part of UE's Forbidden PLMN List and has faced the disaster condition).

PLMN-A1, on which UE is registering for Disaster Roaming services for PLMN-D1 which has faced disaster condition, rejects the registration request of the UE (through any AS or NAS signalling messages, (for example, Registration reject etc.)) with any of the following 5GMM reject causes: 5GMM cause values #11 “PLMN not allowed”, and 5GMM cause values #73 “Serving network not authorized”.

PLMN-A1, on which UE is registering for the disaster roaming service and from which UE gets a 5GMM reject cause (#11 or #73), may be the highest in the priority order (i.e. the most preferred PLMN ID in the list) in the “list of PLMN(s) to be used in disaster condition” stored in the ME/USIM which is associated with the PLMN ID of the MS determined PLMN with disaster condition (for example, PLMN-D1), if any, or:
a. If the ME/USIM does not have a stored “list of PLMN(s) to be used in disaster condition” associated with the PLMN ID of the MS determined PLMN with disaster condition, PLMN-A2 may be the highest in the priority order (i.e., the most preferred PLMN ID in the list) in the “list of PLMN(s) to be used in disaster condition” stored in the ME/USIM which is associated with the PLMN ID of the HPLMN (of the UE), if any; or
b. Optionally, there is no other available PLMN(s) offering disaster roaming services to the UE apart from PLMN-A1; or
c. Optionally, there is no allowable PLMN which can provide normal services to the UE; or
d. Optionally, the MS is not in 5GMM-REGISTERED state and 5GMM-CONNECTED mode over non-3GPP access.

The UE may consider PLMN-A2 as the highest priority PLMN for registering for disaster roaming services and the UE shall select, again, and register (through any AS or NAS signalling messages, for example, Registration Request etc.) using 5GS Registration Type value as “disaster roaming initial registration” or using 5GS Registration Type value as “disaster roaming mobility registration updating” on the PLMN (PLMN-A1).

The PLMN-A2 may reject the registration request of the UE (through any AS or NAS signalling messages (for example, Registration reject etc)), again, with any of the following 5GMM reject causes: 5GMM cause values #11 “PLMN not allowed”, and 5GMM cause values #73 “Serving network not authorized”.

The steps (2-6) may be repeated again and again (for example, in a repetitive manner or in a loop) and the UE may unnecessarily select and register on PLMN-A2 for disaster roaming services even after getting the 5GMM reject cause (#11 or #73). This may lead to unnecessary wastage of UE and Network resources (for example, signalling resources).

Currently, it is not defined how the UE, or the network would avoid a situation to not let the UE to repeatedly register on a PLMN (for ex-PLMN-A1) for disaster roaming services when UE was initially registering on PLMN-A2 for disaster roaming services for PLMN-D1 (which has faced disaster condition) and PLMN-A2 is rejecting the registration request of the UE (through any AS or NAS signalling messages, for example, Registration reject etc.) with any of the 5GMM reject causes (#11 or #73).

The cause #11 is ideally used to insert the current PLMN into the Forbidden PLMN list and trigger PLMN selection. But the UE chooses the PLMN which is already part of the FPLMN list to register for disaster roaming service. Thus, if the UE again gets the #11, then the UE will have to populate again this PLMN in the FPLMN list and trigger PLMN selection. Thus, the UE will again end up selecting the same FPLMN because there is no change in any conditions of the UE and the UE will be in an infinite loop.

Therefore, there is a need of a method and system to overcome or at least alleviate the afore-mentioned drawbacks.

### DISCLOSURE OF INVENTION

### Technical Problem

The principal object of the embodiments herein is to disclose methods and systems for handling Forbidden Public Land Mobile Networks (FPLMNs) for Minimization of service interruption (MINT).

Another object of the embodiments herein is to disclose methods and systems for managing selection of PLMNs in wireless communication networks, during a disaster situation.

Another object of the embodiments herein is to disclose methods and systems for managing selection of PLMNs in wireless communication networks, during a disaster situation, wherein the UE transitions from Disaster Roaming Service to Normal Service on the same PLMN-A when PLMN-A is included in the list of preferred PLMN/access technology combinations provided in the Steering of Roaming (SOR) information to the UE.

Another object of the embodiments herein is to disclose methods and systems for managing selection of PLMNs in wireless communication networks, during a disaster situation, wherein the UE can avail disaster roaming services from PLMN-A1 for other PLMN(s) with disaster condition (for e.g., PLMN-D2) when the UE was initially registered on PLMN-A2 for disaster roaming services for PLMN-D1 (which has faced disaster situation).

### Solution to Problem

Accordingly, the embodiments herein provide a method for managing behaviour of a User Equipment (UE), wherein the UE is registered for disaster roaming service on a Forbidden Public Land Mobile Network (FPLMN). The method comprises the UE removing the FPLMN from a FPLMN list, triggering a deregistration procedure over the FPLMN network; and performing a selection procedure to select at least one of the available PLMN network.

Accordingly, the embodiments herein provide a User Equipment (UE) registered for disaster roaming service on a Forbidden Public Land Mobile Network (FPLMN). The UE comprises a processor; and a memory coupled to the processor. The processor is configured for removing the FPLMN from a FPLMN list; triggering a deregistration procedure over the FPLMN network; and performing a selection procedure to select at least one of the available PLMN network.

Accordingly, the embodiments herein provide a method for managing behaviour of a User Equipment (UE), wherein the UE supports S1 mode. The method comprises the UE attempting to register for disaster roaming service on a PLMN, wherein the UE does not indicate support of S1 mode; and receiving, by the UE, an indication from a network that the UE is registered for normal services. If the UE supports S1 mode, the UE triggers a registration procedure for mobility and periodic registration update with the network; and indicates to the network that the UE supports S1 mode.

Accordingly, the embodiments herein provide a User Equipment (UE), wherein the UE supports S1 mode. The UE comprises a processor; and a memory coupled to the processor. The processor is configured for attempting to register for disaster roaming service on a PLMN, wherein the UE does not indicate support of S1 mode; and receiving an indication from a network that the UE is registered for normal services. If the UE supports S1 mode, the processor can trigger a registration procedure for mobility and periodic registration update with the network; and indicate to the network that the UE supports S1 mode.

These and other aspects of the example embodiments herein will be better ap-preciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Advantageous Effects of Invention

Embodiments of the present disclosure provides methods and apparatus for triggering a deregistration procedure over the FPLMN network and performing a PLMN selection procedure to select at least one of the available PLMN network, in case that the FPLMN that the apparatus is registered for disaster roaming service is removed from a FPLMN list.

Embodiments of present disclosure provides methods and apparatus for receiving S1 mode services in case that the apparatus supports S1 mode, and the apparatus is registered for normal services when the apparatus request registration for disaster roaming.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 depicts a scenario, wherein a UE is trying to transition from Disaster Roaming Service to Normal Service on the same PLMN-A, when the PLMN-A is included in the list of preferred PLMN/access technology combinations provided in the Steering of Roaming (SOR) information to the UE, according to prior arts;

FIG. 2 depicts a scenario, wherein the UE can avail disaster roaming services from PLMN-A2 for other PLMN(s) with disaster condition (for e.g., PLMN-D2) when the UE was initially registered on PLMN-A2 for disaster roaming services for PLMN-D1 (which has faced disaster situation), according to prior arts;

FIG. 3 illustrates a scenario of how to handle abnormal case for receipt of 5GMM cause value, according to prior arts;

FIG. 4 depicts a communication network, comprising one or more network entities and one or more UEs, according to embodiments as disclosed herein;

FIG. 5 shows various hardware components of the UE, according to embodiments as disclosed herein;

FIG. 6 is a flowchart depicting a process of the UE handling FPLMNs for MINT, according to embodiments as disclosed herein;

FIG. 7 is a flowchart depicting a process of the UE handling FPLMNs for MINT, according to embodiments as disclosed herein;

FIG. 8 depicts a scenario, wherein a UE is trying to transition from Disaster Roaming Service to Normal Service on the same PLMN-A, when the PLMN-A is included in the list of preferred PLMN/access technology combinations provided in the SOR information to the UE, according to embodiments as disclosed herein;

FIG. 9 depicts a scenario, wherein the UE can avail disaster roaming services from PLMN-A for other PLMN(s) with disaster condition (for e.g., PLMN-D2) when the UE was initially registered on PLMN-A for disaster roaming services for PLMN-D1 (which has faced disaster situation), according to embodiments as disclosed herein; and

FIG. 10 illustrates a scenario of how to handle abnormal case for receipt of 5GMM cause value, according to embodiments as disclosed herein.

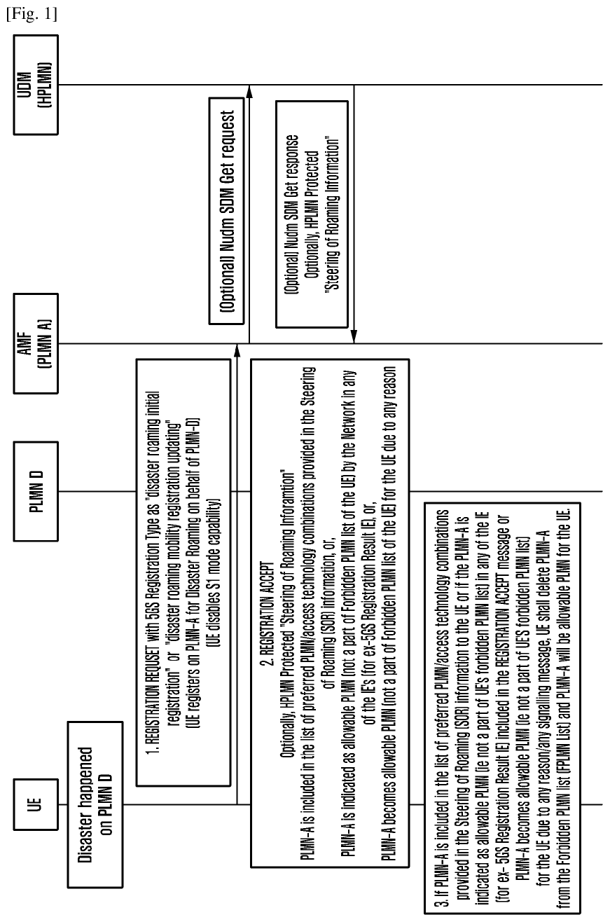

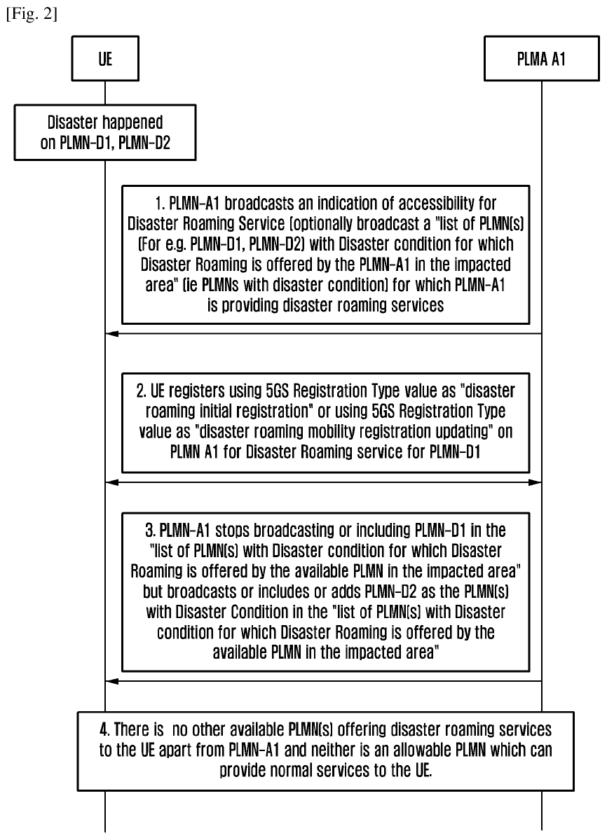

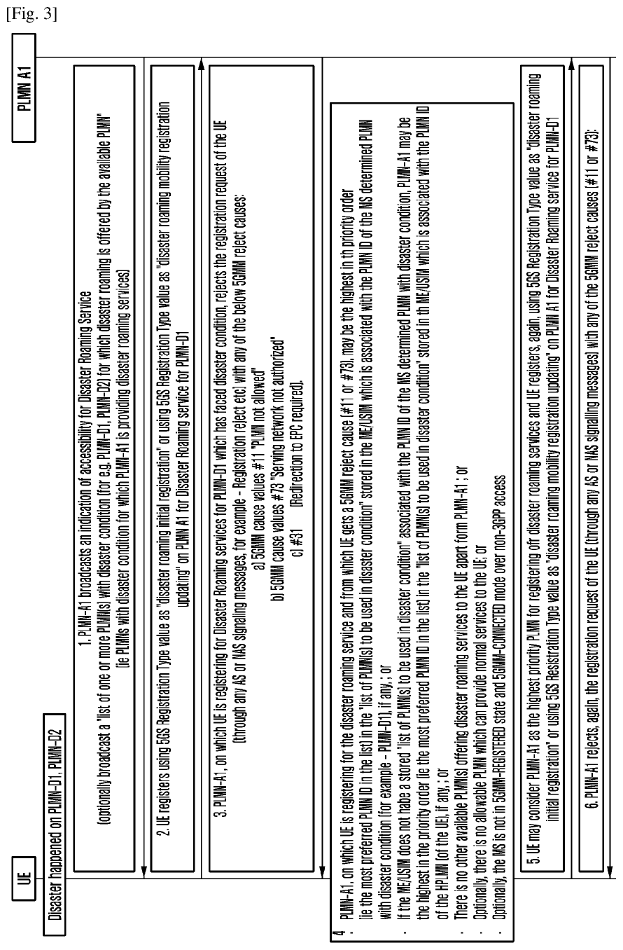

### MODE FOR THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

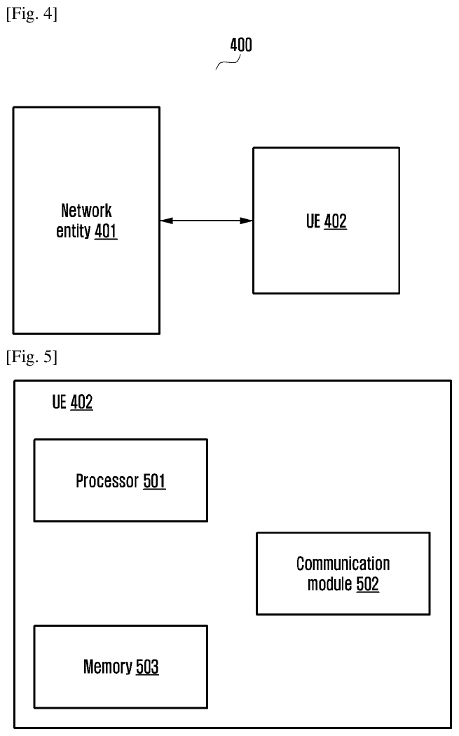

The embodiments herein achieve methods and systems for handling Forbidden Public Land Mobile Networks (FPLMNs) for Minimization of service interruption (MINT). Referring now to the drawings, and more particularly to FIGS. 4 through 10, where similar reference characters denote corresponding features consistently throughout the figures, there are shown example embodiments.

The following abbreviations and definitions have been referred to herein:
G-GUTI-4G—Globally Unique Temporary Identifier
5GCN—5G Core Network
5G-GUTI—5G-Globally Unique Temporary Identifier
5GMM—5GS Mobility Management
5G-RG—5G Residential Gateway
5G-BRG—5G Broadband Residential Gateway
5G-CRG—5G Cable Residential Gateway
5GS—5G System
5GSM—5GS Session Management
5G-S-TMSI—5G S-Temporary Mobile Subscription Identifier
5G-TMSI-5G Temporary Mobile Subscription Identifier
5QI—5G QoS Identifier
ACS—Auto-Configuration Server
AKA—Authentication and Key Agreement
AKMA—Authentication and Key Management for Applications
A-KID—AKMA Key Identifier
A-TID—AKMA Temporary Identifier
AMBR—Aggregate Maximum Bit Rate
AMF—Access and Mobility Management Function
APN-Access Point Name
ATSSS—Access Traffic Steering, Switching and Splitting
AUSF—Authentication Server Function
CAG—Closed access group
CHAP—Challenge Handshake Authentication Protocol
SUCI—Subscription Concealed Identifier
PLMN—Public Land Mobile Network
MS—Mobile Station. The present document makes no distinction between MS and UE.
UE—User Equipment
ME—Mobile Equipment
USIM—Universal Subscriber Identity Module
UDM—Unified Data Management Function
SIM—Subscriber Identity Module
VPLMN—Visited PLMN
HPLMN—Home PLMN
MINT—Minimization of service interruption

Steering of Roaming (SOR): A technique whereby a roaming UE is encouraged to roam to a preferred roamed-to-network indicated by the HPLMN.

Steering of roaming connected mode control information (SOR-CMCI): HPLMN information to control the timing for a UE in connected mode to move to idle mode in order to perform steering of roaming.

Secured packet: In this specification, a secured packet contains one or both of a list of preferred PLMN/access technology combinations; and SOR-CMCI, encapsulated with a security mechanism.

Steering of Roaming information: This comprises the following HPLMN protected information:
a) the following indicators, of whether:
   the UDM requests an acknowledgement from the UE for successful reception of the steering of roaming information.
   the UDM requests the UE to store the SOR-CMCI in the ME, which is provided along with the SOR-CMCI; and
b) one of the following:
1) one or both of a list of preferred PLMN/access technology combinations with an indication that it is included, and SOR-CMCI;
2) a secured packet with an indication that it is included; or
3) the HPLMN indication that ‘no change of the “Operator Controlled PLMN Selector with Access Technology” list stored in the UE is needed and thus no list of preferred PLMN/access technology combinations is provided’, and SOR-CMCI, if any.

Visited PLMN (VPLMN): This is a PLMN different from the HPLMN (if the EHPLMN list is not present or is empty) or different from an EHPLMN (if the EHPLMN list is present).

Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.

Home PLMN: This is a PLMN where the MCC and MNC of the PLMN identity match the MCC and MNC of the IMSI.

Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.

Registration: This is the process of camping on a cell of the PLMN or the SNPN and doing any necessary LRs.

UPLMN: PLMN/access technology combination in the “User Controlled PLMN Selector with Access Technology” data file in the SIM (in priority order).

OPLMN: PLMN/access technology combination in the “Operator Controlled PLMN Selector with Access Technology” data file in the SIM (in priority order) or stored in the ME (in priority order).

Disaster Condition: This is the condition that a government decides when to initiate and terminate, for example, a natural disaster. When this condition applies, users may have the opportunity to mitigate service interruptions and failures.

Disaster Inbound Roamer: A user that cannot get service from the PLMN it would normally be served by, due to failure of service during a Disaster Condition, and is able to register with other PLMNs.

Disaster Roaming: This is the special roaming policy that applies during a Disaster Condition.

PLMN with Disaster Condition: A PLMN to which a Disaster Condition applies.

Registered for disaster roaming services: A UE is considered as “registered for disaster roaming services” when it has successfully completed initial registration or mobility registration for disaster roaming services.

Examples of the NAS messages, as referred to herein can be (but not limited to): REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; UE CONFIGURATION UPDATE command; UE PARAMETERS UPDATE command, and so on.

The term 5GMM sublayer states as referred to herein can be at least one of the below:
1. 5GMM-NULL
2. 5GMM-DEREGISTERED
   a. 5GMM-DEREGISTERED.NORMAL-SERVICE
   b. 5GMM-DEREGISTERED.LIMITED-SERVICE
   c. 5GMM-DEREGISTERED.ATTEMPTING-REGISTRATION
   d. 5GMM-DEREGISTERED.PLMN-SEARCH
   c. 5GMM-DEREGISTERED.NO-SUPI
   f. 5GMM-DEREGISTERED.NO-CELL-AVAILABLE
   g. 5GMM-DEREGISTERED.cCALL-INACTIVE
   h. 5GMM-DEREGISTERED.INITIAL-REGISTRATION-NEEDED
3. 5GMM-REGISTERED-INITIATED
4. 5GMM-REGISTERED
   a. 5GMM-REGISTERED.NORMAL-SERVICE
   b. 5GMM-REGISTERED.NON-ALLOWED-SERVICE
   c. 5GMM-REGISTERED.ATTEMPTING-REGISTRATION-UPDATE
   d. 5GMM-REGISTERED.LIMITED-SERVICE
   c. 5GMM-REGISTERED.PLMN-SEARCH
   f. 5GMM-REGISTERED.NO-CELL-AVAILABLE
   g. 5GMM-REGISTERED.UPDATE-NEEDED
5. 5GMM-DEREGISTERED-INITIATED
6. 5GMM-SERVICE-REQUEST-INITIATED

The term EMM sublayer states as referred to herein can be at least one of the below:
1. EMM-NULL
2. EMM-DEREGISTERED
   a. EMM-DEREGISTERED.NORMAL-SERVICE
   b. EMM-DEREGISTERED.LIMITED-SERVICE
   c. EMM-DEREGISTERED.ATTEMPTING-TO-ATTACH
   d. EMM-DEREGISTERED.PLMN-SEARCH
   c. EMM-DEREGISTERED.NO-IMSI
   f. EMM-DEREGISTERED.ATTACH-NEEDED
   g. EMM-DEREGISTERED.NO-CELL-AVAILABLE
   h. EMM-DEREGISTERED.cCALL-INACTIVE
3. EMM-REGISTERED-INITIATED
4. EMM-REGISTERED
   a. EMM-REGISTERED.NORMAL-SERVICE
   b. EMM-REGISTERED.ATTEMPTING-TO-UPDATE
   c. EMM-REGISTERED.LIMITED-SERVICE
   d. EMM-REGISTERED.PLMN-SEARCH
   c. EMM-REGISTERED.UPDATE-NEEDED
   f. EMM-REGISTERED.NO-CELL-AVAILABLE
   g. EMM-REGISTERED.ATTEMPTING-TO-UPDATE-MM
   h. EMM-REGISTERED.IMSI-DETACH-INITIATED
5. EMM-DEREGISTERED-INITIATED
6. EMM-TRACKING-AREA-UPDATING-INITIATED
7. EMM-SERVICE-REQUEST-INITIATED

The term RAT as referred to herein can be one of the following:
NG-RAN
5G, 4G, 3G, 2G
EPS, 5GS
NR
a. NR in unlicensed bands
b. NR (LEO) satellite access
c. NR (MEO) satellite access
d. NR (GEO) satellite access
e. NR (OTHERSAT) satellite access
f. NR RedCap
g. E-UTRA
h. E-UTRA in unlicensed bands
i. NB-IOT
j. WB-IoT
k. LTE-M

5GS registration types can be, but not limited to, initial registration, mobility registration updating, periodic registration updating, emergency registration, SNPN onboarding registration, disaster roaming initial registration; disaster roaming mobility registration updating, and so on.

Not set the registration type to disaster roaming initial registration or disaster roaming mobility registration updating means 5GS registration type is set to value other than “disaster roaming initial registration” or “disaster roaming mobility registration updating” at least one of initial registration, mobility registration updating, periodic registration updating, emergency registration, SNPN onboarding registration, and so on.

The terms ‘disaster based service’, ‘disaster roaming service’ and ‘disaster inbound roaming’ are used interchangeably herein and have the same meaning. The terms ‘disaster situation’ and ‘disaster condition’ are used interchangeably in this embodiment and have the same meaning.

The terms ‘PLMN D’ and ‘PLMN-D’ are used interchangeably in this embodiment and refer to the same entity. The terms ‘PLMN A’ and ‘PLMN-A’ are used interchangeably in this embodiment and refer to the same entity.

The terms UE and MS are used interchangeably in this embodiment and have the same meaning.

The term or method where “UE is registering for the disaster roaming service” or “UE is registered for the disaster roaming service” may refer to a situation or condition, but not restricted or limited to, where UE sets or indicates the Fifth Generation System (5GS) Registration type IE to at least one of a “disaster roaming initial registration” and a “disaster roaming mobility registration updating” in the REGISTRATION REQUEST message.

The term area/location/geographical area are used in this embodiment may refer to any of cell/cell ID, TAC/TAI, PLMN, MCC/MNC, Latitude/longitude, CAG cell or any geographical location/coordinate.

Embodiments as disclosed herein are applicable to any (but not limited to) of the RAT(s) as defined in this embodiment.

The network as referred to herein can be any 5G/EUTRAN Core Network Entities like AMF/SMF/MME/UPF or the network could be any (but not limited to) 5G/EUTRAN RAN Entity like eNodeB (cNB) or gNodeB (gNB) or NG-RAN etc.

Embodiments herein disclose methods and systems for managing selection of PLMNs in wireless communication networks, during a disaster situation. Embodiments herein disclose methods and systems for managing selection of PLMNs in wireless communication networks, during a disaster situation, wherein the UE transitions from Disaster Roaming Service to Normal Service on the same PLMN-A when PLMN-A is included in the list of preferred PLMN/access technology combinations provided in the Steering of Roaming (SOR) information to the UE. Embodiments herein methods and systems for managing selection of PLMNs in wireless communication networks, during a disaster situation, wherein the UE can avail disaster roaming services from PLMN-A for other PLMN(s) with disaster condition (for e.g., PLMN-D2) when the UE was initially registered on PLMN-A for disaster roaming services for PLMN-D1 (which has faced disaster situation).

FIG. 4 depicts a communication network, comprising one or more network entities and one or more UEs. The network 400, as depicted, comprises one or more network entities 401, and at least one UE 402. In an embodiment herein, the network entity 401 can be an AMF (PLMN-A), wherein the AMF can be a Forbidden Public Land Mobile Network (FPLMN) for the UE 402. In an embodiment herein, the UE 402 can be registered for disaster roaming service on the FPLMN 401 (PLMN-A, in the current example). Embodiments herein use the terms ‘the network entity’, ‘PLMN-A’, ‘FPLMN’, ‘network’, ‘VPLMN’ and so on to refer to the network entity 401 inter-changcably.

Consider that the network entity 401 sends Steering of Roaming (SOR) information to the UE. In an embodiment herein, the SOR information comprises the FPLMN (i.e., PLMN-A). In an embodiment herein, the network entity 401 can send the SOR information as a Short Message Service (SMS) message. When the SOR information is received as part of a SMS or using the data channel/data path to the UE, the received SOR information is sent to the USIM module in the UE. The USIM stores the SOR information in a corresponding file (such as, OPLMN list) and is updated with the latest SOR information sent from the network. The USIM module sends the Universal SIM Application Toolkit (USAT) REFRESH command qualifier of type “SOR from the USIM to the ME. In an embodiment herein, the network entity 401 can send the SOR information as an updated “Operator Controlled PLMN Selector with Access Technology” list. In an embodiment herein, the network entity 401 can send the SOR information as a NAS message, wherein the NAS message can be at least one of a registration accept message; and a DL NAS TRANSPORT message. In summary, the ME receives the new updated SOR information; i.e., the OPLMN list, now this OPLMN list also comprises of the FPLMN, this implies this FPLMN is an allowable PLMN for the UE now.

On receiving the SOR information from the network entity 401, the UE 402 can remove the PLMN-A from a FPLMN list. The FPLMN list is a listing of FPLMNs for the UE 402. The UE 402 can further trigger a deregistration procedure from the FPLMN 401. The UE 402 can perform a PLMN selection procedure to select another PLMN (whichever is available in the area).

In an embodiment herein, the UE 402 can support S1 mode. However, when attempting to register with the FPLMN 401 for disaster roaming service, the UE 402 does not indicate to the FPLMN 401 that it supports S1 mode. In an embodiment herein, the UE 402 can attempt to register for disaster roaming services on the FPLMN 401 using 5GS Registration Type IE set as “Disaster roaming initial registration”. In an embodiment herein, the UE 402 can attempt to register for disaster roaming services on the FPLMN 401 using 5GS Registration Type IE set as “Disaster roaming mobility registration updating”.

The FPLMN 401 can indicate to the UE 402 that the UE 402 is registered for normal services. In an embodiment herein, the FPLMN 401 can provide this indication to the UE 402 by setting a Fifth Generation System (5GS) registration result Information Element (IE) value in a REGISTRATION ACCEPT message by indicating “request for registration for disaster roaming service accepted as registration not for disaster roaming service”.

On receiving the indication from the FPLMN 401 and as the UE 402 supports S1 mode, the UE 402 triggers a registration procedure for mobility and periodic registration update with the FPLMN 401. The UE 402 can further indicate to the FPLMN 401 that the UE 402 supports S1 mode.

FIG. 5 shows various hardware components of the UE 402, according to embodiments as disclosed herein. In an embodiment, the UE 402 includes a processor 501, a communication module 502, and a memory 503. The processor 501 can be coupled with the communication 502, and the memory 503.

The processor 501 can be implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor 501 can be configured to execute instructions stored in the memory 503 and to perform various processes. The communication module 502 configured for communicating internally between internal hardware components and with external devices via one or more networks. The memory 503 can also store instructions to be executed by the processor 501. The memory 503 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 503 may, in some examples, be considered a non-transitory storage medium. The term “non-transitory” may indicate that the storage medium is not embodied in a carrier wave or a propagated signal. However, the term “non-transitory” should not be interpreted that the memory 503 is non-movable. In certain examples, a non-transitory storage medium may store data that can, over time, change (e.g., in Random Access Memory (RAM) or cache).

In an embodiment herein, the UE 402 can be registered for disaster roaming service on the FPLMN 401 (PLMN-A, in the current example).

On receiving the SOR information from the network entity 401 (wherein the received SOR information comprises the FPLMN), the processor 501 can remove the PLMN-A from a FPLMN list. In an embodiment herein, the processor 501 can receive the SOR information as a Short Message Service (SMS) message. In an embodiment herein, the processor 501 can receive the SOR information as a USAT REFRESH command qualifier of type “SOR from the USIM. In an embodiment herein, the processor 501 can receive the SOR information as an updated “Operator Controlled PLMN Selector with Access Technology” list. In an embodiment herein, the processor 501 can receive the SOR information as a NAS message, wherein the NAS message can be at least one of a registration accept message; and a DL NAS TRANSPORT message. The processor 501 can further trigger a deregistration procedure from the FPLMN 401. The processor 501 can perform a PLMN selection procedure to select another PLMN (i.e., a PLMN that is not the FPLMN 401).

In an embodiment herein, the UE 402 supports S1 mode. However, when attempting to register with the FPLMN 401 for disaster roaming service, the processor 501 docs not indicate to the FPLMN 401 that it supports S1 mode. In an embodiment herein, the processor 501 can attempt to register for disaster roaming services on the FPLMN 401 using 5GS Registration Type IE set as “Disaster roaming initial registration”. In an embodiment herein, the processor 501 can attempt to register for disaster roaming services on the FPLMN 401 using 5GS Registration Type IE set as “Disaster roaming mobility registration updating”.

On receiving the indication from the FPLMN 401 that the UE 402 is registered for normal services and as the UE 402 supports S1 mode, the processor 501 triggers a registration procedure for mobility and periodic registration update with the FPLMN 401. The processor 501 can further indicate to the FPLMN 401 that the UE 402 supports S1 mode.

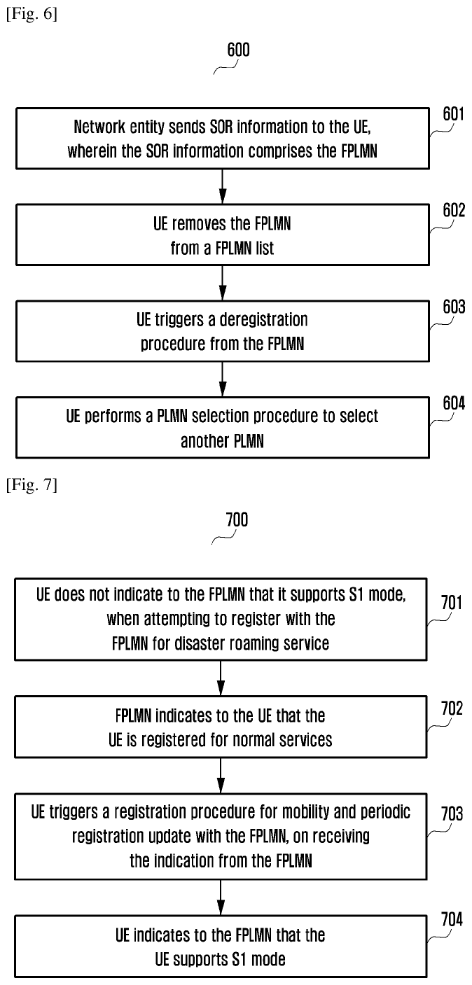

FIG. 6 is a flowchart depicting a process of the UE handling FPLMNs for MINT. The UE 402 is registered for disaster roaming service on the FPLMN 401. In step 601, the network entity 401 sends Steering of Roaming (SOR) information to the UE 402, which comprises the FPLMN (i.e., PLMN-A) as at least one of a SMS message, as a USAT REFRESH command qualifier of type “SOR from the USIM, as an updated “Operator Controlled PLMN Selector with Access Technology” list, and/or as a NAS message (which can be at least one of a registration accept message; and a DL NAS TRANSPORT message). On receiving the SOR information from the network entity 401, in step 602, the UE 402 removes the PLMN-A from a FPLMN list. In step 603, the UE 402 further triggers a deregistration procedure from the FPLMN 401. In step 604, the UE 402 performs a PLMN selection procedure to select another PLMN (for example, a PLMN that is not the FPLMN 401). The various actions in method 600 may be performed in the order presented, in a different order or simultaneously. Further, in some embodiments, some actions listed in FIG. 6 may be omitted.

FIG. 7 is a flowchart depicting a process of the UE handling FPLMNs for MINT. In an embodiment herein, the UE 402 can support S1 mode. When attempting to register with the FPLMN 401 for disaster roaming service, in step 701, the UE 402 does not indicate to the FPLMN 401 that it supports S1 mode. In an embodiment herein, the UE 402 attempts to register for disaster roaming services on the FPLMN 401 using 5GS Registration Type IE set as “Disaster roaming initial registration”. In an embodiment herein, the UE 402 can attempt to register for disaster roaming services on the FPLMN 401 using 5GS Registration Type IE set as “Disaster roaming mobility registration updating”. In step 702, the FPLMN 401 indicates to the UE 402 that the UE 402 is registered for normal services. In an embodiment herein, the FPLMN 401 provides this indication to the UE 402 by setting a 5GS registration result IE value in a REGISTRATION ACCEPT message by indicating “request for registration for disaster roaming service accepted as registration not for disaster roaming service”. On receiving the indication from the FPLMN 401 and as the UE 402 supports S1 mode, in step 703, the UE 402 triggers a registration procedure for mobility and periodic registration update with the FPLMN 401. In step 704, the UE 402 further indicates to the FPLMN 401 that the UE 402 supports S1 mode (for example, as part of the 5GMM capability IE). The various actions in method 700 may be performed in the order presented, in a different order or simultaneously. Further, in some embodiments, some actions listed in FIG. 7 may be omitted.

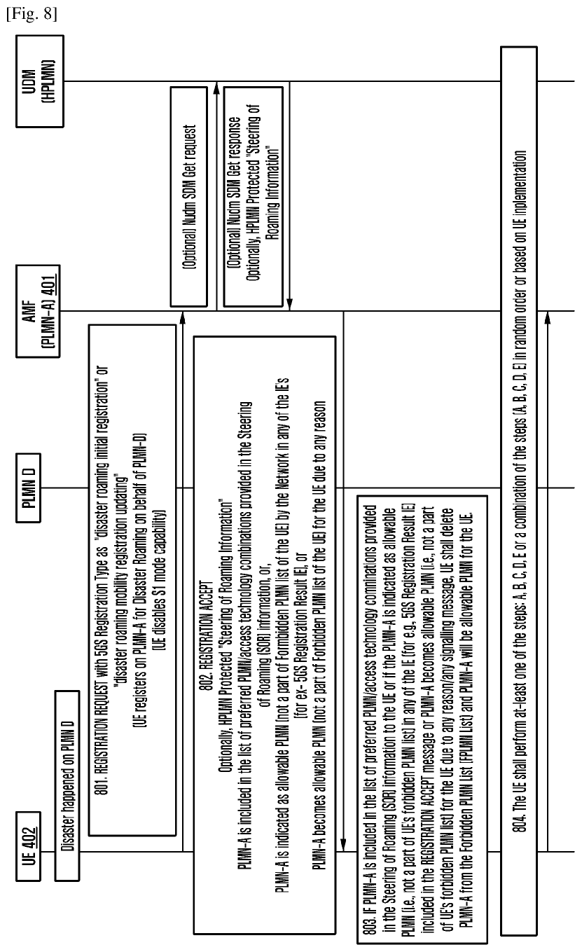

FIG. 8 depicts a scenario, wherein a UE is trying to transition from Disaster Roaming Service to Normal Service on the same PLMN-A 401, when the PLMN-A 401 is included in the list of preferred PLMN/access technology combinations provided in the Steering of Roaming (SOR) information to the UE 402. In step 801, a UE 402 supporting Disaster Roaming or Minimization of Service Interruption (MINT), in a disaster situation, can select and register using 5GS Registration Type value as “disaster roaming initial registration” or using 5GS Registration Type value as “disaster roaming mobility registration updating” on a PLMN (PLMN-A) which is present in the FPLMN list of the UE 402 and providing disaster roaming services to the UE 402 on behalf of a PLMN (PLMN-D) 801 (which is allowable or not a part of UE's Forbidden PLMN List and has faced the disaster situation). PLMN-D 801 is an allowable PLMN for the UE 402, i.e., PLMN-D 801 is not part of the UE's FPLMN list and PLMN-D 801 has faced disaster situation. PLMN-A is part of the UE's Forbidden PLMN List (FPLMN List). PLMN-A is available and providing disaster roaming services to the UE 402 on behalf of PLMN-D 801 which has faced a disaster situation. If the UE 402 is registered on a Visited PLMN i.e., VPLMN (PLMN-A) 401 for Disaster Roaming services, the UE 402 shall disable the S1 mode. If the UE 402 supports S1 mode, the UE 402 may not indicate the S1 mode support in the REGISTRATION REQUEST message or the UE 402 may set the S1 mode bit to “S1 mode not supported” in the 5GMM capability IE of the REGISTRATION REQUEST message or the UE 402 shall indicate to the network (any network function or entity) through AS/NAS signalling message that S1 mode is not supported for the UE 402, if the UE 402 is registering for disaster roaming services.

In step 802, if the UE 402 is registered on Visited PLMN i.e., VPLMN (PLMN-A) for Disaster Roaming services, the HPLMN can provide the SOR information to the UE 402 in the DL NAS TRANSPORT message or via any AS/NAS Signalling Message. In an embodiment herein, the PLMN-A 401 becomes an allowable PLMN (i.e., not a part of UE 402's forbidden PLMN list) for the UE 402 due to any reason or through any AS/NAS signalling message.

In step 803, if PLMN-A 401 (on which the UE 402 is registered for Disaster Roaming services) is included in the list of preferred PLMN/access technology combinations provided in the SOR information to the UE 402 or if the PLMN-A 401 is indicated as an allowable PLMN (i.e., not a part of the UE's forbidden PLMN list) in any of the IE (for example, 5GS Registration Result IE) included in the NAS message for example REGISTRATION ACCEPT message or the UE configuration update message or if the PLMN-A 401 becomes an allowable PLMN (i.e., not a part of UE 402's forbidden PLMN list) for the UE 402 due to any reason or through any AS/NAS signalling message, the UE 402 shall delete PLMN-A 401 from the FPLMN List and PLMN-A 401 will be an allowable PLMN for the UE 402.

In step 804, the UE 402 shall perform at-least one of the below steps in any of the combinations:

A. The UE 402 shall trigger a registration procedure with 5GS Registration Type “mobility registration updating” to indicate to any network entity that the PLMN-A 401 is an allowable PLMN (i.e., PLMN-A 401 is not part of UE's Forbidden PLMN List) and the UE 402 is registering for normal services (i.e., not registering for any of disaster roaming initial registration or not disaster roaming mobility registration updating). If the UE 402 supports S1 mode, the UE 402 may indicate the S1 mode support in the REGISTRATION REQUEST message or the UE 402 may set the S1 mode bit to “S1 mode supported” in the 5GMM capability IE of the REGISTRATION REQUEST message or the UE 402 shall indicate to the network (any network function or entity, which may be the FPLMN 401, or any other entity, such as, but not limited to, a NG-RAN, a Unified Data Management (UDM), an Authentication Server Function (AUSF), a gNB, and so on) through AS/NAS signalling message that S1 mode is supported for the UE 402.

B. The UE 402 shall set the GMM state to 5GMM-REGISTERED with substate AT-TEMPTING-REGISTRATION-UPDATE and set the 5GS update status to 5U2 NOT UPDATED. UE 402 shall stay in the current serving cell and apply normal cell selection or cell reselection process. In an embodiment herein, the UE 402 shall set the GMM state to 5GMM-REGISTERED with substate PLMN-SEARCH and perform PLMN Selection procedure. In an embodiment herein, the UE 402 shall set the GMM state to 5GMM-REGISTERED with substate UPDATE-NEEDED and perform Cell selection/reselection procedure. If the UE 402 supports S1 mode, the UE 402 may indicate the S1 mode support in the REGISTRATION REQUEST message or the UE 402 may set the S1 mode bit to “S1 mode supported” in the 5GMM capability IE of the REGISTRATION REQUEST message or the UE 402 shall indicate to the network (any network function or entity) through AS/NAS signalling message that S1 mode is supported for the UE 402.

C. The UE 402 shall set the GMM state to 5GMM-DEREGISTERED with substate ATTEMPTING-REGISTRATION and set the 5GS update status to 5U2 NOT UPDATED. The UE 402 shall initiate initial registration procedure. In an embodiment herein, the UE 402 shall set the GMM state to 5GMM-DEREGISTERED with substate PLMN-SEARCH and perform PLMN Selection procedure. If the UE 402 supports S1 mode, the UE 402 may indicate the S1 mode support in the REGISTRATION REQUEST message or the UE 402 may set the S1 mode bit to “S1 mode supported” in the 5GMM capability IE of the REGISTRATION REQUEST message or the UE 402 shall indicate to the network (any network function or entity) through AS/NAS signalling message that S1 mode is supported for the UE 402.

D. The UE 402 shall trigger DEREGISTRATION REQUEST via any AS/NAS Signalling (for e.g. Detach Request) to deregister from the network. The UE 402 shall perform initial registration on PLMN-A with 5GS Registration Type “initial registration”. In an embodiment herein, the UE 402 may perform registration procedure on PLMN-A 401 with any of the 5GS Registration Type from the following: “initial registration”, or “mobility registration updating”, or “periodic registration updating”, or “emergency registration”, or “SNPN onboarding registration”. In an embodiment herein, the UE 402 may perform registration procedure on PLMN-A 401 with any 5GS Registration Type other than “disaster roaming initial registration” and “disaster roaming mobility registration updating” (i.e. the UE 402 can register with 5GS registration type not equal to disaster roaming initial registration or disaster roaming mobility registration updating). If the UE 402 supports S1 mode, the UE 402 may indicate the S1 mode support in the REGISTRATION REQUEST message or the UE 402 may set the S1 mode bit to “S1 mode supported” in the 5GMM capability IE of the REGISTRATION REQUEST message or the UE 402 shall indicate to the network (any network function or entity) through AS/NAS signalling message that S1 mode is supported for the UE 402.

E. The UE 402 shall perform PLMN Selection or PLMN-SEARCH procedure and register for available services (i.e., normal services if normal services is available). If the UE 402 supports S1 mode, the UE 402 may indicate the S1 mode support in the REGISTRATION REQUEST message or the UE 402 may set the S1 mode bit to “S1 mode supported” in the 5GMM capability IE of the REGISTRATION REQUEST message or the UE 402 shall indicate to the network (any network function or entity) through AS/NAS signalling message that S1 mode is supported for the UE 402.

The UE 402 shall perform any of the above (A or B or C or D or E) or a combination of any of the above in random order or based on UE implementation.

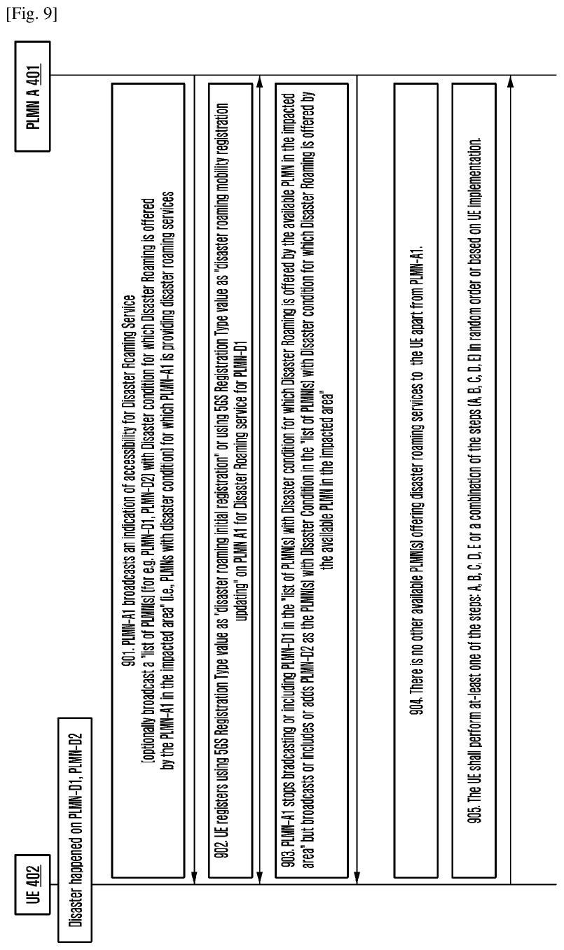

FIG. 9 depicts a scenario, wherein the UE 402 can avail disaster roaming services from PLMN-A 401 for other PLMN(s) with disaster condition (for e.g., PLMN-D2) when the UE 402 was initially registered on PLMN-A for disaster roaming services for PLMN-D1 (not shown) (which has faced disaster situation). PLMN-D1 is an allowable PLMN for the UE 402, i.e., PLMN-D1 is not part of UE's FPLMN list and PLMN-D1 has faced disaster situation. PLMN-D2 (not shown) is an allowable PLMN for the UE 402, i.e., PLMN-D2 is not part of UE's FPLMN list and PLMN-D2 has faced disaster situation.

In step 901, the PLMN-A 401 is part of the UE's FPLMN list. The PLMN-A 401 is alive and is broadcasting an indication of accessibility for Disaster Roaming Service to the UE 402. The PLMN-A 401 can optionally broadcast a “list of PLMN(s) with Disaster condition (for e.g. PLMN-D1, PLMN-D2) for which Disaster Roaming is offered by the available PLMN in the impacted area”.

In step 902, the UE 402 supporting Disaster Roaming or Minimization of Service Interruption (MINT), in a disaster situation, can select and register using 5GS Registration Type value as “disaster roaming initial registration” or using 5GS Registration Type value as “disaster roaming mobility registration updating” on a PLMN (PLMN-A 401) which is present in the FPLMN list of the UE 402 and providing disaster roaming services to the UE 402 on behalf of a PLMN (PLMN-D1) (which is allowable or not a part of the UE's Forbidden PLMN List and has faced the disaster situation).

In step 903, the PLMN-A 401, on which UE 402 is registered for Disaster Roaming services for PLMN-D1 which has faced disaster situation, stops broadcasting or including PLMN-D1 in the “list of PLMN(s) with Disaster condition for which Disaster Roaming is offered by the available PLMN in the impacted area”, but broadcasts or includes or adds PLMN-D2 as the PLMN(s) with Disaster Condition in the “list of PLMN(s) with Disaster condition for which Disaster Roaming is offered by the available PLMN in the impacted area”.

In step 904, there is no other available PLMN(s) offering disaster roaming services to the UE 402 apart from PLMN-A 401. In step 905, the UE 402 shall perform at-least one of the below steps in any combination:

A. The UE 402 shall trigger a registration procedure with 5GS Registration Type “disaster roaming mobility registration updating” to indicate to the Network or PLMN-A 401 that PLMN-D2 is an allowable PLMN (i.e., PLMN-D2 is not part of UE's FPLMN list) and the UE 402 is registering on PLMN-A 401 for disaster roaming services on behalf of PLMN-D2 (i.e., the UE 402 determined PLMN with disaster condition is now PLMN-D2); i.e., the UE 402 indicates MS determined PLMN with disaster condition as PLMN-D2 in NAS message like registration request message using MS determined PLMN with disaster condition IE or 5G-GUTI.

B. The UE 402 shall set the GMM state to 5GMM-REGISTERED with substate AT-TEMPTING-REGISTRATION-UPDATE and set the 5GS update status to 5U2 NOT UPDATED. The UE 402 shall stay in the current serving cell and apply normal cell selection or cell reselection process. In an embodiment herein, the UE 402 shall set the GMM state to 5GMM-REGISTERED with substate PLMN-SEARCH and perform PLMN Selection procedure. In an embodiment herein, the UE 402 shall set the GMM state to 5GMM-REGISTERED with substate UPDATE-NEEDED and perform cell selection/reselection procedure.

C. The UE 402 shall set the GMM state to 5GMM-DEREGISTERED with substate ATTEMPTING-REGISTRATION and set the 5GS update status to 5U2 NOT UPDATED. The UE 402 shall initiate disaster roaming registration procedure. In an embodiment herein, the UE 402 shall set the GMM state to 5GMM-DEREGISTERED with substate PLMN-SEARCH and perform PLMN Selection procedure.

D. The UE 402 shall trigger DEREGISTRATION REQUEST via any AS/NAS Signalling (for e.g. Detach Request) to deregister from the network. The UE 402 shall perform disaster roaming registration on PLMN-A with 5GS Registration Type “disaster roaming initial registration” or “disaster roaming mobility registration updating” and indicate the UE 402 determined PLMN with disaster condition as PLMN-D2.

E. The UE 402 shall perform PLMN Selection or PLMN-SEARCH procedure and register for available services (i.e., disaster roaming services, if normal services are not available).

The UE 402 shall perform any of the above (A or B or C or D or E) or a combination of any of the above in random order or based on UE implementation.

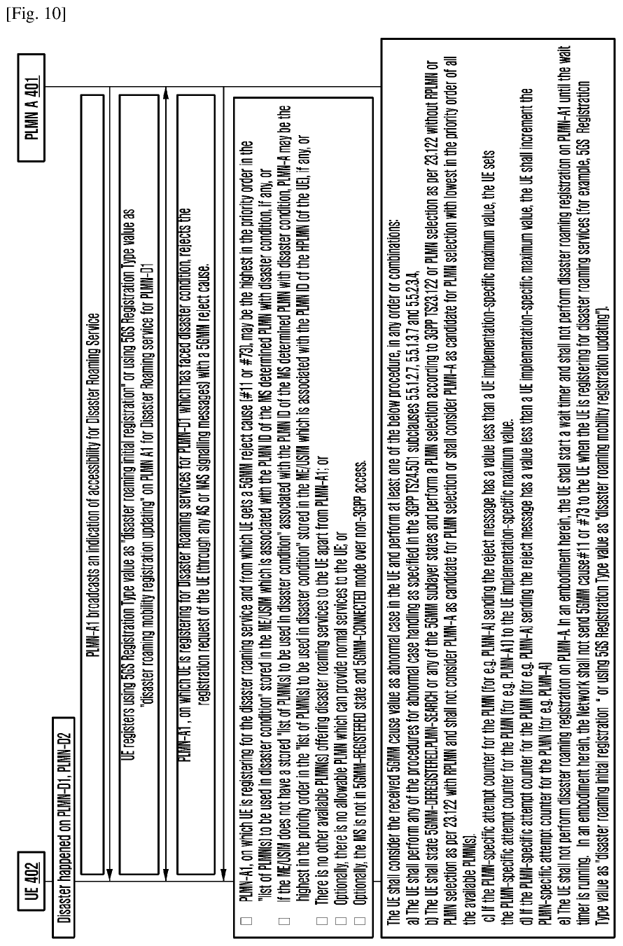

FIG. 10 illustrates a scenario of how to handle abnormal case for receipt of 5GMM cause value, according to embodiments as disclosed herein. Consider that PLMN-D1 (not shown) is an allowable PLMN for the UE 402; i.e., PLMN-D1 is not part of the UE's FPLMN list and PLMN-D1 has faced disaster condition. PLMN-D2 (not shown) is an allowable PLMN for the UE 402; i.e., PLMN-D2 is not part of the UE's FPLMN list and PLMN-D2 has faced disaster condition. PLMN-A 401 is part of UE's FPLMN list or present in the list of “forbidden PLMNs” or the list of “forbidden PLMNs for GPRS service”. PLMN-A 401 is alive and is broadcasting an indication of accessibility for Disaster Roaming Service to the UE 402. PLMN-A 401 can optionally broadcast a “list of one or more PLMN(s) with disaster condition (for e.g., PLMN-D1, PLMN-D2) for which disaster roaming is offered by the available PLMN”.

The UE 402 supporting Disaster Roaming or Minimization of Service Interruption (MINT), in a disaster condition, can select and register (through any AS or NAS signalling messages (for example, Registration Request etc.)) using 5GS Registration Type value as “disaster roaming initial registration” or using 5GS Registration Type value as “disaster roaming mobility registration updating” on a PLMN (PLMN-A 401) which is present in the FPLMN list of the UE 402 and providing disaster roaming services to the UE 402 on behalf of a PLMN (PLMN-D1) (which is allowable or not a part of UE's FPLMN list and has faced the disaster condition).

The PLMN-A 401, on which UE 402 is registering for Disaster Roaming services for PLMN-D1 (which has faced disaster condition), rejects the registration request of the UE 402 (through any AS or NAS signalling messages, for example, Registration reject etc.) with any of the following example 5GMM reject causes: 5GMM cause values #11 “PLMN not allowed”, 5GMM cause values #73 “Serving network not authorized”, #31 (Redirection to EPC required), and so on.

PLMN-A 401, on which UE 402 is registering for the disaster roaming service and from which UE 402 gets a 5GMM reject cause (#11 or #73 or #31), may be the highest in the priority order, as PLMN-A 401is the most preferred PLMN ID in the list, in the “list of PLMN(s) to be used in disaster condition” stored in the ME/USIM which is associated with the PLMN ID of the MS determined PLMN with disaster condition (for example, PLMN-D1), if any; or

A. If the ME/USIM does not have a stored “list of PLMN(s) to be used in disaster condition” associated with the PLMN ID of the MS determined PLMN with disaster condition, the PLMN-A 401 may be the highest in the priority order (i.e., the most preferred PLMN ID in the list) in the “list of PLMN(s) to be used in disaster condition” stored in the ME/USIM which is associated with the PLMN ID of the HPLMN (of the UE 402), if any; or

B. Optionally, there is no other available PLMN(s) offering disaster roaming services to the UE 402 apart from PLMN-A 401; or

C. Optionally, there is no allowable PLMN which can provide normal services to the UE 402; or

D. Optionally, the MS is not in 5GMM-REGISTERED state and 5GMM-CONNECTED mode over non-3GPP access.

The UE 402 shall consider the received 5GMM cause value (#11 or #73) as an abnormal case in the UE 402 (if the UE 402 is registering for the disaster roaming service) and perform at-least one of the below procedure, in any order or combinations:

1. The UE 402 shall perform any of the procedures for abnormal case handling as specified in the 3GPP TS 24.501 subclauses 5.5.1.2.7, 5.5.1 . . . 3.7 and 5.5.2.3.4 or later as discussed herein in “Abnormal case handling for disaster roaming mobility registration updating” or Abnormal case handling for disaster roaming initial registration.

2. The UE 402 shall enter state 5GMM-DEREGISTERED.PLMN-SEARCH or any of the 5GMM sublayer states and perform a PLMN selection according to 3GPP TS 23.122 or PLMN selection as per 23.122 without RPLMN or PLMN selection as per 23.122 with RPLMN and shall not consider PLMN-A 401 as a candidate for PLMN selection or shall consider PLMN-A 401 as candidate for PLMN selection with lowest in the priority order of all the available PLMN(s) or available FPLMNs(s).

3. If the PLMN-specific attempt counter for the PLMN (for e.g., PLMN-A 401) sending the reject message has a value less than a UE 402 implementation-specific maximum value, the UE 402 sets the PLMN-specific attempt counter for the PLMN (for e.g., PLMN-A 401) to the UE implementation-specific maximum value.

4. If the PLMN-specific attempt counter for the PLMN (for e.g., PLMN-A 401) sending the reject message has a value less than a UE 402 implementation-specific maximum value, the UE 402 shall increment the PLMN-specific attempt counter for the PLMN (for e.g., PLMN-A 401).

5. The UE 402 shall not perform disaster roaming registration on PLMN-A 401. In an embodiment herein, the UE 402 shall start a wait timer and shall not perform disaster roaming registration on PLMN-A 401 until the wait timer is running.

6. The UE 402 shall enter the state 5GMM-DEREGISTERED.LIMITED-SERVICE or any of the 5GMM sublayer states. In an embodiment herein, the UE 402 shall enter state 5GMM-DEREGISTERED.PLMN-SEARCH and perform a PLMN selection according to 3GPP TS 23.122 or PLMN selection as per 23.122 without RPLMN or PLMN selection as per 23.122 with RPLMN.

7. The UE 402 shall set the 5GS update status to 5U3 ROAMING NOT ALLOWED and shall delete, the 5G-GUTI, last visited registered TAI, TAI list, ngKSI for 3GPP access and the list of equivalent PLMNs. Additionally, if a registration procedure was performed, the UE 402 shall reset the registration attempt counter and if a service request procedure was performed, reset the service request attempt counter.

8. The UE 402 shall start timer T3502 and shall set the 5GS update status to 5U2 NOT UPDATED. The state is changed to 5GMM-DEREGISTERED.ATTEMPTING-REGISTRATION or optionally to 5GMM-DEREGISTERED.PLMN-SEARCH in order to perform a PLMN selection, SNPN selection according to 3GPP TS 23.122 or PLMN selection as per 23.122 without RPLMN or PLMN selection as per 23.122 with RPLMN.

9. The UE 402 shall increment the registration attempt counter, unless it was already set to 5.

10. The UE 402 shall stop Timer T3510, if still running.

11. The UE 402 shall start timer T3511, and the state is changed to

5GMM-DEREGISTERED.ATTEMPTING-REGISTRATION. When timer T3511 expires, the registration procedure for disaster roaming registration shall be restarted, if still required.

12. If the UE 402 does not change to state 5GMM-REGISTERED.PLMN-SEARCH, the UE 402 shall attempt to select E-UTRAN radio access technology. In an embodiment herein, the UE 402 shall attempt to select E-UTRAN radio access technology by enabling S1 mode if the UE 402 supports S1 mode. The UE 402 may disable the N1 mode capability.

In an embodiment herein, the network shall not send 5GMM cause #11 or #73 to the UE 402 when the UE 402 is registering for disaster roaming services (for example, 5GS Registration Type value as “disaster roaming initial registration” or using 5GS Registration Type value as “disaster roaming mobility registration updating”).

Example abnormal case handling for disaster roaming initial registration is as follows:
Timer T3510 shall be stopped if still running.
If the registration procedure is neither an initial registration for emergency services nor for establishing an emergency PDU session with registration type not set to “emergency registration”, the registration attempt counter shall be incremented, unless it was already set to 5.
If the registration attempt counter is less than 5:
If the initial registration request is not for emergency services, timer T3511 is started, and the state is changed to 5GMM-DEREGISTERED.ATTEMPTING-REGISTRATION. When timer T3511 expires the registration procedure for initial registration shall be restarted, if still required.
If the registration attempt counter is equal to 5
the UE 402 shall delete 5G-GUTI, TAI list, last visited registered TAI, list of equivalent PLMNs (if any), and ngKSI, start timer T3502 and shall set the 5GS update status to 5U2 NOT UPDATED. The state is changed to 5GMM-DEREGISTERED.ATTEMPTING-REGISTRATION or optionally to 5GMM-DEREGISTERED.PLMN-SEARCH in order to perform a PLMN selection, SNPN selection according to 3GPP TS 23.122.
If the procedure is performed via 3GPP access and the UE 402 is operating in single-registration mode:
the UE 402 shall in addition handle the EMM parameters EPS update status, EMM state, 4G-GUTI, TAI list, last visited registered TAI, list of equivalent PLMNs and cKSI, as specified in 3GPP TS 24.301 for the abnormal cases when an EPS attach procedure fails and the attach attempt counter is equal to 5; and
the UE 402 shall attempt to select E-UTRAN radio access technology and proceed with appropriate EMM specific procedures. Additionally, The UE 402 may disable the N1 mode capability as specified in subclause 4.9.

Example abnormal case handling for 5GS registration type set to disaster roaming mobility registration updating in registration request message is as follows—
Timer T3510 shall be stopped if still running.
If the registration procedure is not for initiating an emergency PDU session, the registration attempt counter shall be incremented, unless it was already set to 5.
If the registration attempt counter is less than 5:
If the TAI of the current serving cell is not included in the TAI list or the 5GS update status is different to 5U1 UPDATED or if the registration procedure was triggered due to cases c, g, n, v in subclause 5.5.1.3.2, the UE 402 shall start timer T3511, shall set the 5GS update status to 5U2 NOT UPDATED and change to state 5GMM-REGISTERED.ATTEMPTING-REGISTRATION-UPDATE. When timer T3511 expires, the registration update procedure is triggered again.
If the TAI of the current serving cell is included in the TAI list, the 5GS update status is equal to 5U1 UPDATED, and the UE 402 is not performing the registration procedure after an inter-system change from S1 mode to N1 mode, the UE 402 shall keep the 5GS update status to 5U1 UPDATED and enter state 5GMM-REGISTERED.NORMAL-SERVICE or 5GMM-REGISTERED.NON-ALLOWED-SERVICE (as described in subclause 5.3.5.2). The UE 402 shall start timer T3511. If in addition the REGISTRATION REQUEST message did not include the MICO indication IE or the Extended DRX IE, and
The REGISTRATION REQUEST message indicated “periodic registration updating”;
The registration procedure was initiated to recover the NAS signalling connection due to “RRC Connection failure” from the lower layers; or
The registration procedure was initiated by the UE 402 in 5GMM-CONNECTED mode with RRC inactive indication entering a cell in the current registration area belonging to an equivalent PLMN of the registered PLMN and not belonging to the registered PLMN,
And none of the other reasons for initiating the registration updating procedure listed in subclause 5.5.1.3.2 was applicable, the timer T3511 may be stopped when the UE 402 enters 5GMM-CONNECTED mode.
If the TAI of the current serving cell is included in the TAI list, the 5GS update status is equal to 5U1 UPDATED and the UE 402 is performing the registration procedure after an inter-system change from S1 mode to N1 mode, the UE 402 shall change the 5GS update status to 5U2 NOT UPDATED and enter state 5GMM-REGISTERED.ATTEMPTING-REGISTRATION-UPDATE. The UE 402 shall start timer T3511.
If the procedure is performed via 3GPP access and the UE 402 is operating in single-registration mode, the UE 402 shall in addition handle the EPS update status as specified in 3GPP TS 24.301 for the abnormal cases when a normal or periodic tracking area updating procedure fails and the tracking area attempt counter is less than 5 and the EPS update status is different from EUI UPDATED.
If the registration attempt counter is equal to 5
The UE 402 shall start timer T3502, shall set the 5GS update status to 5U2 NOT UPDATED.
The UE 402 shall delete the list of equivalent PLMNs (if any) and shall change to state 5GMM-REGISTERED.ATTEMPTING-REGISTRATION-UPDATE or optionally to 5GMM-REGISTERED.PLMN-SEARCH in order to perform a PLMN selection, SNPN selection or SNPN selection for onboarding services according to 3GPP TS 23.122.
If the procedure is performed via 3GPP access and the UE 402 is operating in single-registration mode:
the UE 402 shall in addition handle the EPS update status as specified in 3GPP TS 24.301 for the abnormal cases when a normal or periodic tracking area updating procedure fails and the tracking area attempt counter is equal to 5; and
if the UE 402 does not change to state 5GMM-REGISTERED.PLMN-SEARCH, the UE 402 shall attempt to select E-UTRAN radio access technology. The UE 402 may disable the N1 mode capability as specified in subclause 4.9.

If UE 402 has not set the registration type to disaster roaming initial registration or disaster roaming mobility registration updating, the UE 402 shall set the 5GS update status to 5U3 ROAMING NOT ALLOWED (and shall store it according to subclause 5.1.3.2.2) and shall delete any 5G-GUTI, last visited registered TAI, TAI list and ngKSI. The UE 402 shall delete the list of equivalent PLMNs and reset the registration attempt counter and store the PLMN identity in the forbidden PLMN list as specified in subclause 5.3.13A and if the UE 402 is configured to use timer T3245 then the UE 402 shall start timer T3245 and proceed as described in clause 5.3.19a.1. For 3GPP access the UE 402 shall enter state 5GMM-DEREGISTERED.PLMN-SEARCH and perform a PLMN selection according to 3GPP TS 23.122 [5], and for non-3GPP access the UE 402 shall enter state 5GMM-DEREGISTERED.LIMITED-SERVICE and perform network selection as defined in 3GPP TS 24.502. If the message has been successfully integrity checked by the NAS and the UE 402 maintains the PLMN-specific attempt counter and the PLMN-specific attempt counter for non-3GPP access for that PLMN, the UE 402 shall set the PLMN-specific attempt counter and the PLMN-specific attempt counter for non-3GPP access for that PLMN to the UE 402 implementation-specific maximum value.

If the message was received via 3GPP access and the UE 402 is operating in single-registration mode, the UE 402 shall in addition handle the EMM parameters EMM state, EPS update status, 4G-GUTI, last visited registered TAI, TAI list, cKSI, and attach attempt counter as specified in 3GPP TS 24.301 for the case when the EPS attach request procedure is rejected with the EMM cause with the same value.

If the message has been successfully integrity checked by the NAS and the UE 402 also supports the registration procedure over the other access to the same PLMN, the UE 402 shall in addition handle 5GMM parameters and 5GMM state for this access, as described for this 5GMM cause value.

If UE 402 has not set the registration type to disaster roaming initial registration or disaster roaming mobility registration updating, the UE 402 shall set the 5GS Update status to 5U3 ROAMING NOT ALLOWED (and shall store it according to subclause 5.1.3.2.2) and shall delete any 5G-GUTI, last visited registered TAI, TAI list and ngKSI. The UE 402 shall delete the list of equivalent PLMNs and reset the registration attempt counter and store the PLMN identity in the forbidden PLMN list as specified in subclause 5.3.13A and if the UE 402 is configured to use timer T3245 then the UE 402 shall start timer T3245 and proceed as described in clause 5.3.19a.1. For 3GPP access, the UE 402 shall enter state 5GMM sublayer state for example 5GMM-DEREGISTERED.PLMN-SEARCH and perform a PLMN selection according to 3GPP TS 23.122, and for non-3GPP access the UE 402 shall enter 5GMM sublayer state for example 5GMM-DEREGISTERED.LIMITED-SERVICE and perform network selection as defined in 3GPP TS 24.502. If the message has been successfully integrity checked by the NAS and the UE 402 maintains the PLMN-specific attempt counter and the PLMN-specific attempt counter for non-3GPP access for that PLMN, the UE 402 shall set the PLMN-specific attempt counter and the PLMN-specific attempt counter for non-3GPP access for that PLMN to the UE 402 implementation-specific maximum value.

If the message was received via 3GPP access and the UE 402 is operating in single-registration mode, the UE 402 shall in addition handle the EMM parameters EMM state, EPS update status, 4G-GUTI, last visited registered TAI, TAI list, eKSI and attach attempt counter as specified in 3GPP TS 24.301 for the case when the EPS attach request procedure is rejected with the EMM cause with the same value.

If the message has been successfully integrity checked by the NAS and the UE 402 also supports the registration procedure over the other access to the same PLMN, the UE 402 shall in addition handle 5GMM parameters and 5GMM state for this access, as described for this 5GMM cause value.

All subclauses in this embodiment herein (unless explicitly mentioned) refer to TS 24.501.

Embodiments herein are explained by taking reject cause #11 as an example, same issue and handling as disclosed herein can be applied for at least any of the reject causes, as depicted in table 1.

TABLE 1

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 1 | 1 | Illegal UE |
| 0 | 0 | 0 | 0 | 0 | 1 | 0 | 1 | PEI not accepted |
| 0 | 0 | 0 | 0 | 0 | 1 | 1 | 0 | Illegal ME |
| 0 | 0 | 0 | 0 | 0 | 1 | 1 | 1 | 5GS services not allowed |
| 0 | 0 | 0 | 0 | 1 | 0 | 0 | 1 | UE identity cannot be derived by the network |
| 0 | 0 | 0 | 0 | 1 | 0 | 1 | 0 | Implicitly de-registered |
| 0 | 0 | 0 | 0 | 1 | 0 | 1 | 1 | PLMN not allowed |
| 0 | 0 | 0 | 0 | 1 | 1 | 0 | 0 | Tracking area not allowed |
| 0 | 0 | 0 | 0 | 1 | 1 | 0 | 1 | Roaming not allowed in this tracking area |
| 0 | 0 | 0 | 0 | 1 | 1 | 1 | 1 | No suitable cells in tracking area |
| 0 | 0 | 0 | 1 | 0 | 1 | 0 | 0 | MAC failure |
| 0 | 0 | 0 | 1 | 0 | 1 | 0 | 1 | Synch failure |
| 0 | 0 | 0 | 1 | 0 | 1 | 1 | 0 | Congestion |
| 0 | 0 | 0 | 1 | 0 | 1 | 1 | 1 | UE security capabilities mismatch |
| 0 | 0 | 0 | 1 | 1 | 0 | 0 | 0 | Security mode rejected, unspecified |
| 0 | 0 | 0 | 1 | 1 | 0 | 1 | 0 | Non-5G authentication unacceptable |
| 0 | 0 | 0 | 1 | 1 | 0 | 1 | 1 | N1 mode not allowed |
| 0 | 0 | 0 | 1 | 1 | 1 | 0 | 0 | Restricted service area |
| 0 | 0 | 0 | 1 | 1 | 1 | 1 | 1 | Redirection to EPC required |
| 0 | 0 | 1 | 0 | 1 | 0 | 1 | 1 | LADN not available |
| 0 | 0 | 1 | 1 | 1 | 1 | 1 | 0 | No network slices available |
| 0 | 1 | 0 | 0 | 0 | 0 | 0 | 1 | Maximum number of PDU sessions reached |
| 0 | 1 | 0 | 0 | 0 | 0 | 1 | 1 | Insufficient resources for specific slice and DNN |
| 0 | 1 | 0 | 0 | 0 | 1 | 0 | 1 | Insufficient resources for specific slice |
| 0 | 1 | 0 | 0 | 0 | 1 | 1 | 1 | ngKSI already in use |
| 0 | 1 | 0 | 0 | 1 | 0 | 0 | 0 | Non-3GPP access to 5GCN not allowed |
| 0 | 1 | 0 | 0 | 1 | 0 | 0 | 1 | Serving network not authorized |
| 0 | 1 | 0 | 0 | 1 | 0 | 1 | 0 | Temporarily not authorized for this SNPN |
| 0 | 1 | 0 | 0 | 1 | 0 | 1 | 1 | Permanently not authorized for this SNPN |
| 0 | 1 | 0 | 0 | 1 | 1 | 0 | 0 | Not authorized for this CAG or authorized for CAG |
| | | | | | | | | cells only |
| 0 | 1 | 0 | 0 | 1 | 1 | 0 | 1 | Wireline access area not allowed |
| 0 | 1 | 0 | 0 | 1 | 1 | 1 | 0 | PLMN not allowed to operate at the present UE location |
| 0 | 1 | 0 | 0 | 1 | 1 | 1 | 1 | UAS services not allowed |
| 0 | 1 | 0 | 1 | 1 | 0 | 1 | 0 | Payload was not forwarded |
| 0 | 1 | 0 | 1 | 0 | 0 | 0 | 0 | Disaster roaming for the determined PLMN with disaster |
| | | | | | | | | condition not allowed |
| 0 | 1 | 0 | 1 | 1 | 0 | 1 | 1 | DNN not supported or not subscribed in the slice |
| 0 | 1 | 0 | 1 | 1 | 1 | 0 | 0 | Insufficient user-plane resources for the PDU session |
| 0 | 1 | 0 | 1 | 1 | 1 | 0 | 1 | Onboarding services terminated |
| 0 | 1 | 0 | 1 | 1 | 1 | 1 | 1 | Semantically incorrect message |
| 0 | 1 | 1 | 0 | 0 | 0 | 0 | 0 | Invalid mandatory information |
| 0 | 1 | 1 | 0 | 0 | 0 | 0 | 1 | Message type non-existent or not implemented |
| 0 | 1 | 1 | 0 | 0 | 0 | 1 | 0 | Message type not compatible with the protocol state |
| 0 | 1 | 1 | 0 | 0 | 0 | 1 | 1 | Information element non-existent or not implemented |
| 0 | 1 | 1 | 0 | 0 | 1 | 0 | 0 | Conditional IE error |
| 0 | 1 | 1 | 0 | 0 | 1 | 0 | 1 | Message not compatible with the protocol state |
| 0 | 1 | 1 | 0 | 1 | 1 | 1 | 1 | Protocol error, unspecified |

The embodiments disclosed herein can be implemented through at least one software program running on at least one hardware device and performing network management functions to control the elements. The elements shown in FIGS. 4 and 5 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

1-12. (canceled)

13. A method performed by a user equipment (UE), wherein the UE is registered for disaster roaming service on a forbidden public land mobile network (FPLMN), the method comprising:
receiving, from a base station, steering of roaming (SOR) information,
removing the FPLMN from a FPLMN list based on the SOR information;
triggering a deregistration procedure over the FPLMN network; and
performing a PLMN selection procedure to select at least one available PLMN network.

14. The method of claim 13, wherein the UE receives the SOR information by at least one of a USAT REFRESH command qualifier, an updated operator controlled PLMN selector with access technology list, or a NAS message.

15. The method of claim 13, further comprising:
receiving, from the base station, an indication that the UE is registered for normal service;
in case that the UE supports S1 mode, triggering a registration procedure for mobility and periodic registration update with the network; and
in case that the UE supports S1 mode, indicating to the base station that the UE supports S1 mode.

16. The method of claim 15,
wherein whether the UE supports S1 mode is not indicated in the PLMN selection procedure.

17. The method of claim 15,
wherein the UE is configured for attempting to register for disaster roaming services on the PLMN using 5GS Registration Type IE set as at least one of a disaster roaming initial registration or a Disaster roaming mobility registration updating.

18. The method of claim 15, further comprising:
receiving, from the base station, a registration accept message including fifth generation system (5GS) registration result information which indicates that a request for registration for disaster roaming service is accepted as registration not for disaster roaming service.

19. A user equipment (UE) registered for disaster roaming service on a forbidden public land mobile network (FPLMN), the UE comprising:
a transceiver; and
a processor coupled with the transceiver and configured to:
receive, from a base station, steering of roaming (SOR) information,
remove the FPLMN from a FPLMN list based on the SOR information,
trigger a deregistration procedure over the FPLMN network, and
perform a PLMN selection procedure to select at least one available PLMN network.

20. The UE of claim 19, wherein the UE receives the SOR information by at least one of a USAT REFRESH command qualifier, an updated operator controlled PLMN selector with access technology list, or a NAS message.

21. The UE of claim 19,
wherein the processor is further configured to:
receive, from the base station, an indication that the UE is registered for normal service,
in case that the UE supports S1 mode, trigger a registration procedure for mobility and periodic registration update with the network, and
in case that the UE supports S1 mode, indicate to the base station that the UE supports S1 mode.

22. The UE of claim 21,
wherein whether the UE supports S1 mode is not indicated in the PLMN selection procedure.

23. The UE of claim 21,
wherein the UE is configured for attempting to register for disaster roaming services on the PLMN using 5GS Registration Type IE set as at least one of a disaster roaming initial registration or a Disaster roaming mobility registration updating.

24. The UE of claim 21,
wherein the processor is further configured to:
receive, from the base station, a registration accept message including fifth generation system (5GS) registration result information which indicates that a request for registration for disaster roaming service is accepted as registration not for disaster roaming service.
